(19) United States
(12) Patent Application Publication
(10) Pub. No.: US 2005/0250434 A1
(43) Pub. Date: Nov. 10, 2005

(54) Device for fixation of door on HVAC for automobile

(76) Inventor: Man Hee Kim, Seoul (KR)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/117,132

(22) Filed: Apr. 28, 2005

(30) Foreign Application Priority Data
Apr. 28, 2004 (KR) 2004-0029528

(51) Int. Cl. B60H 1/26

(52) U.S. Cl. 454/139

(57) ABSTRACT

The present invention relates to a door fixation apparatus for a vehicle air conditioner that is capable of preventing various doors or dampers that are installed in an air conditioner from partially opening due to wind pressure when a vehicle is operating or an air conditioner is operated in a state that the doors or dampers are closed. The door fixation apparatus includes a magnetic body that forms at least part of a ventilation opening and closing of the door of the vehicle air conditioner; an electromagnet that is installed adjacent a ventilation opening so that at least part of the magnetic body of the door is magnetically adhered to the electromagnet in a blocking position of the ventilation opening; a power source that supplies the current for magnetizing the electromagnet; and a controller to judge the opening and closing state of the ventilation opening and control a current supply of the power source.

### FIELD OF THE INVENTION

The present invention relates to a door fixation apparatus of automobile air conditioner technology, which prevents the movement of the various doors (or dampers) by wind pressure that are installed in an air conditioner air intake apparatus or duct to control the internal/external air changes and the wind amounts.

### BACKGROUND OF THE INVENTION

The automobile's HVAC (Heating, Ventilating & Air Conditioning) system for the cold/warm air control comprises the heat exchanger and blower units. It is operated by flowing cold/warm air or ventilation through the duct that is connected from the vehicle's exterior to the interior.

The attached FIG. 1 illustrates an air intake part of this HVAC system to which an evaporator (100), situated in the HVAC case (200) supplies the internal/external air inward. As shown, inside of HVAC case (200) is installed with an evaporator (100) and a blower (400) in the direction of internal/external air entry (310,320). The air intake door (600) is installed in the air intake case (500) which is facing the blower (400) in the center of the internal/external air entry (310,320). The air intake door (600) connects the actuator (700) through the lever (710) and link material (720), and when the control switch is turned on, the blower (400) and the actuator (700) are in operation, then, according to the internal/external air intake and ventilation modes, air intake door (600) selects the open or close position of internal/external air entry (310,320) and cold/warm air change is achieved. Specifically, when the actuator (700) is in operation, the lever (710) which is attached to the air intake door (600), positions to either internal air entry (310) or the external air entry (320) in accordance with HVAC system's operation mode and internal/external air entry is achieved normally. For example, when it is in the internal air circulation mode, the air intake door (600) positions to the external air entry (320) and blocks the external air entry, allowing only the internal air entry; in the external air entry mode, the air intake door (600) positions toward the internal air entry (310), blocks the internal air entry and allows only the external air entry.

However, if the automobile is moving at a high speed while in the internal circulation mode, the exterior air pressure applies force onto the external air entry (320), partially opening the air intake door (600) that was shielding the external air entry (320), and causing the entry of external air through the opening crack. Consequently, the opening crack suctions in air pressure and causes not only the abnormal noise (air current noise) problem, but decreases air/heating functioning in the automobile HVAC system.

Furthermore, when the automobile is on external air intake mode, the air intake door (600) which was shielding the internal air entry (310) is forced open by the suction pressure from the blower (400), thus causing noise as previously described.

In order to improve these problems and to make the air intake door resistant to the external air pressures, some structural changes such as a 2-door (800,800′) and a round shaped door were implemented as shown in FIG. 2. It was difficult to solve the above-described problems completely with these changes, and, due to the limited space, difficulty to apply these changes continued.

Further, as explained with FIG. 1 for the air intake door, the previously described problems are common with the automobile ventilator's wind amount controlling door, the temperature controlling door, and the wind direction controlling door or the dampers. Improvement in these areas is also required.

### SUMMARY OF THE INVENTION

As described before, this invention has been developed to improve the existing problems. The purpose of this invention is to provide a door fixation apparatus for a vehicle air conditioner, which prevents partial openings of various doors and dampers that are attached in the air conditioner by wind pressure when a vehicle or the air conditioner is operated and when the doors or dampers are closed.

In order to achieve the above purpose, in one form, this invention's door fixation apparatus for a vehicle air conditioner is comprised of the following technical concepts: a magnetic body that forms at least a portion of a ventilation opening and closing door in the vehicle air conditioner; an electromagnet that is installed at a shielding position of a ventilation port so that the magnetic body in the door is magnetically adhered to the shielding position of the ventilation port; a power source that supplies a current for magnetizing the electromagnet; and a controller for evaluating the opening and closing state of the above ventilation port, and controlling the current supply of the power source.

In accordance with one feature of the invention, a door fixation apparatus is provided for a vehicle air conditioner. The apparatus includes a magnetic body that forms at least a portion of a ventilation opening and closing door of a vehicle air conditioner, an electromagnet installed adjacent to a ventilation opening of the vehicle air conditioner so that at least part of the magnetic body of the door magnetically adheres to the electromagnet in a blocking position of the ventilation opening; a power source that supplies a current for magnetizing the electromagnet; and a controller to evaluate the open and closed state of the ventilation opening and to control the current supply of the power source.

Other objects, features, and advantages of the invention will become apparent from a review of the entire specification, including the appended claims and drawings.

### BRIEF DESCRIPTION OF THE DRAWINGS

FIG. 1 is a somewhat diagrammatic illustration of a prior art HVAC air intake system;

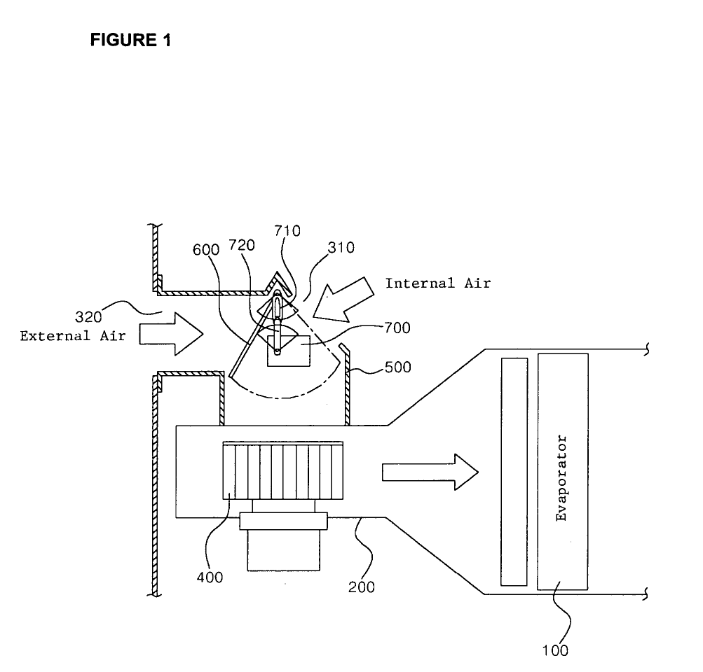

FIG. 2 is a somewhat diagrammatic illustration of another prior art HVAC system with a 2-door structure; and

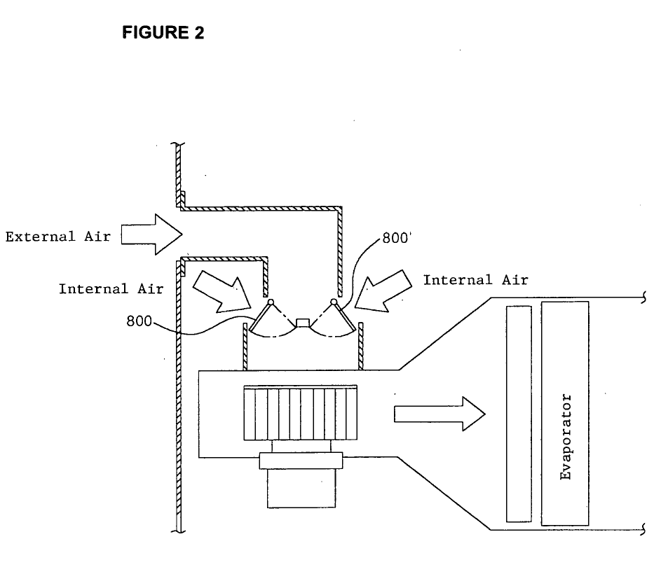

FIG. 3 is a somewhat diagrammatic illustration of the present invention in which a door fixation apparatus is applied to an air intake in a HVAC system.

### DETAILED DESCRIPTION OF THE PREFERRED EMBODIMENT

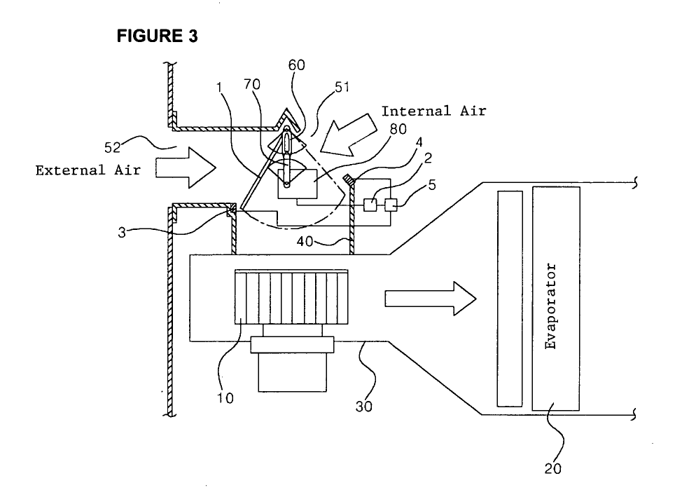

The attached FIG. 3 illustrates the invention's applicable example of a door fixation apparatus and its related devices that attach the air intake door to the HVAC system.

As shown, an air intake case (40) is mounted on the HVAC case (30) to which a blower (10) and an evaporator (20) are installed to draw vehicle internal/external air, and this air intake case (40) is installed with an air intake door (1) that opens and closes the ventilator selectively for internal air entry (51) and external air entry (52). This air intake door (1) is operable in the opening/closing of the above internal/external entry (51,52) by connecting to the actuator (80) through the lever (60) and link material (70), when the actuator (80) is activated. Also, the actuator (80) is connected to the controller (2) so that the vehicle operator can control its activation accordingly. The controller (2) consists of a general microcomputer.

This invention's door fixation apparatus is comprised of the following:

First, the air intake door (1) itself or a part of the door (1) has an iron or iron alloy magnetic body. For example, the air intake door (1) achieves the blocking the internal air entry (51) or the external air entry (52) in the air intake case (40) by the magnetic body from the part of the air intake door (1) which contacts with the blower (10) end of the internal/external air entry (51,52). To realize the magnetic attachments and the attachment between the magnetic body of the air intake door (1) and a blocking position of the internal/external air entry (51,52), electromagnets (3,4) are installed at each of the blower (10) ends of the internal/external air entry (51,52). In addition, power source (5) which is necessary to supply the current for magnetizing the electromagnets (3,4) can be provided by the vehicle battery. Further, in order to magnetize the above electromagnets (3,4), a controller for a power source (5) that supplies the current is provided by the controller (2) which also evaluates the opening/closing state of the internal/external air entry (51,52). According to the applied mode, for opening/closing of the internal air entry (51) and the external air entry (52), the internal air circulation of the air conditioner or the external air intake is achieved.

The following explains the functioning of the door fixation apparatus for the above components from this invention.

First, in the air conditioner's internal air circulation mode, the actuator (80) is operated by the controller's (2) signal, and then external air entry (52) is blocked by the air intake door (1). At this time, the above controller (2) allows the current of the power source (5) to flow and magnetizes the electromagnet (3) for the external air entry (52), thus allowing the air intake door (1) magnetic body part to attach to the electromagnet (3) which is mounted on the end part of the external air entry (52). This allows the air intake door (1) to be in contact with the electromagnet (3) of the external air entry (52) magnetically and maintain a firm attached state.

In the same manner, while in the air conditioner's external air intake mode, the actuator (80) is operated by the controller's (2) signal, then internal air entry (51) is blocked by air intake door (1). However, in this case, the above controller (2) allows the current from power source (5) to flow and magnetizes the electromagnet (4), so that the air intake door (1) magnetic body part is attached to the electromagnet (4) which is mounted on the end of the internal air entry (51). This allows the air intake door (1) to be in contact with the electromagnet (4) of the internal air entry (51) magnetically and maintains a firm attached state.

In this way, this invention's door fixation apparatus will make it possible for the door (1) and electromagnets (3,4) to make a magnetic contact, allowing the door (1) to remain firmly closed at either of the internal/external air entry (51,52). This reduces the problem of the door's (1) partial opening caused by external wind pressure or the blower's (10) intake pressure when the vehicle is operating.

So far the explanation is applied to the examples of this invention's door fixation apparatus on the air intake door of the air intake area in the described Figures. However, this invention is not limited to the foregoing. It does not only commonly apply to the air intake door of the air intake area, but also to other various doors, such as the vehicle air conditioner's wind amount control door, the temperature control door, and the wind direction control door. Therefore, the true protection of this invention's technical idea should be defined by the range of attached patent claims.

As explained above, this invention's vehicle air conditioner's door fixation apparatus attaches the various doors or dampers that are installed in the air conditioner to maintain closing and prevents partial opening by wind pressure when the vehicle is operating or the air conditioner is in use. In addition, it not only can prevent the abnormal noise from air intake through existing door crack's caused by wind pressure, but also can improve the vehicle's HVAC cooling/heating functions.

1. A door fixation apparatus for a vehicle air conditioner, comprising:
a magnetic body that forms at least a portion of a ventilation opening and closing door of a vehicle air conditioner;
an electromagnet installed adjacent to a ventilation opening of the vehicle air conditioner so that at least part of the magnetic body of the door magnetically adheres to the electromagnet in a blocking position of the ventilation opening;
a power source that supplies a current for magnetizing the electromagnet; and
a controller to evaluate the open and closed state of the ventilation opening and to control the current supply of the power source.
